(19) United States
(12) Patent Application Publication
(10) Pub. No.: US 2008/0265667 A1
(43) Pub. Date: Oct. 30, 2008

(54) Bolt together machine track and method

(76) Inventor: Richard E. Livesay, Peoria, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(21) Appl. No.: 11/789,273

(22) Filed: Apr. 24, 2007

(51) Int. Cl. B62D 55/205; B62D 25/16

(52) U.S. Cl. 305/202; 305/102

(57) ABSTRACT

A machine includes a bolt together track having sets of straight track links positioned in parallel and coupled via at least one pin. Retainer assemblies for the first and second sets of track links include at least one keeper engageable with the at least one pin and a keeper retainer configured to rotationally interlock with the track segment via threads, to inhibit disassembly of the keepers from the at least one pin. An assembly method for a machine track segment includes positioning first and second sets of track links on at least one pin, installing keepers on the at least one pin and inhibiting disassembly of the links by interlocking keeper retainers with the machine track segment, for instance rotationally interlocking the keeper retainers via external threads with threaded bores in the track links.

### TECHNICAL FIELD

The present disclosure relates generally to machine track and related assembly and disassembly strategies, and relates more particularly to a bolt together machine track and method wherein retainers inhibit disassembly.

### BACKGROUND

A variety of machine tracks have been used for construction, mining and agricultural machines, military vehicles, conveyors and torque transmitting devices for well over a century. In general terms, a machine track consists of an endless chain of track links coupled together and extending about rolling elements. In the case of ground engaging tracks, such as those used to propel mobile machines, a toothed rotating element, commonly known as a drive sprocket, is often used to rotate a track about one or more idlers and a plurality of track rollers supporting the weight of the machine. Such tracks are in widespread use, and have earned a place as indispensable components of many machines operating in rugged environments. The durability, utility and resultant commercial success of tracks used in track-type machines is in large part a result of many decades of research and engineering of their numerous specialized components. While many designs have proven well-suited to rugged off-road environments, where track-type machines typically operate, a drawback to virtually all viable track designs is the difficulty in disassembling or “breaking” the track for service, part replacement or machine disassembly.

One design utilizes pins to couple track links together to form sets of parallel endless track chains. In certain of these designs, a single pin couples together an inboard link and an outboard link in each of the parallel chains. Track shoes coupled with the respective chains provide the elements which engage the ground for propelling the machine. Press fits are often used to provide a robust connection between the pin and the associated track links. To disassemble most tracks having press fits, and particularly those having S-shaped links, a relatively large hydraulic press is typically required to press the pin out of the track. Even after removing the pin, seals used to retain lubricating fluid and protect components from entry of foreign material may resist further disassembly of the track, necessitating the use of an additional hydraulic press to complete track disassembly at a given joint. Great care is often required to avoid damaging the track components during disassembly. Tracks having straight links are often serviced by pulling outboard links off of the ends of track pins rather than pressing out the pins.

Due to the time, care and specialized tools required to disassemble machine track, it has become common to use master links in a track. While master links provide relatively easier disassembly of a track at a given joint, they often still require specialized tools and provide only a single point at which the track can be broken. Master links are also relatively extensively machined parts, and hence expensive, and in some instances can create a weak point in the track.

One track system having a unique, robust design is described in commonly owned U.S. Pat. No. 4,265,084 to Livesay. In the design shown in the '084 patent, an apparatus for locating coacting links on a track pin utilizes keepers and pressed-in end caps at opposite ends of the track pin. While the disclosed strategy appears to provide for relatively simple track assembly, and overcomes problems associated with variations in link thickness, the press fits of the end caps into the links must be overcome to disassemble the track.

The present disclosure is directed to one or more of the problems or shortcomings set forth above.

### SUMMARY OF THE INVENTION

In one aspect, the present disclosure provides a machine track. The track includes a plurality of track segments each having a first set of links, a second set of links positioned in parallel with the first set and at least one pin coupling together the respective links of each set. Each of the plurality of track segments further includes a first retainer assembly for the first set of links and a second retainer assembly for the second set of links, each of the retainer assemblies includes at least one keeper engageable with the at least one pin via a keeper retainer. Each keeper retainer includes an inner diameter, an outer diameter and an interlocking feature disposed on at least one of the inner and outer diameters.

In another aspect, the present disclosure provides an assembly for coupling together components of a machine track. The assembly includes a track link pin, at least one keeper engaged with the pin, and a keeper retainer configured to maintain the at least one keeper in engagement with the pin. The keeper retainer has an inner diameter, an outer diameter and an interlocking feature disposed on at least one of the inner and outer diameters.

In still another aspect, the present disclosure provides a method of assembling a machine track including a step of positioning a first set of track links and a second set of track links on at least one pin. The method further includes the steps of installing keepers on the at least one pin at positions outboard of the respective sets of track links, and inhibiting disassembly of the links from the at least one pin at least in part by engaging keeper retainers with the machine track segment via an interlocking feature of each of the keeper retainers.

### BRIEF DESCRIPTION OF THE DRAWINGS

FIG. 1 is a side diagrammatic view of a machine according to one embodiment;

FIG. 2 is a sectioned view, in perspective, of a machine track according to one embodiment;

FIG. 3 is an exploded view of a portion of a machine track according to one embodiment;

FIG. 4 is a sectioned view through a machine track similar to that shown in FIG. 2;

FIG. 5 is a sectioned view of a machine track according to one embodiment;

FIG. 6 is a partially sectioned view of a portion of a machine undercarriage according to one embodiment;

FIG. 7 is a sectioned view of a portion of a machine track according to one embodiment; and

FIG. 8 is a sectioned view of a portion of a machine track according to one embodiment.

### DETAILED DESCRIPTION

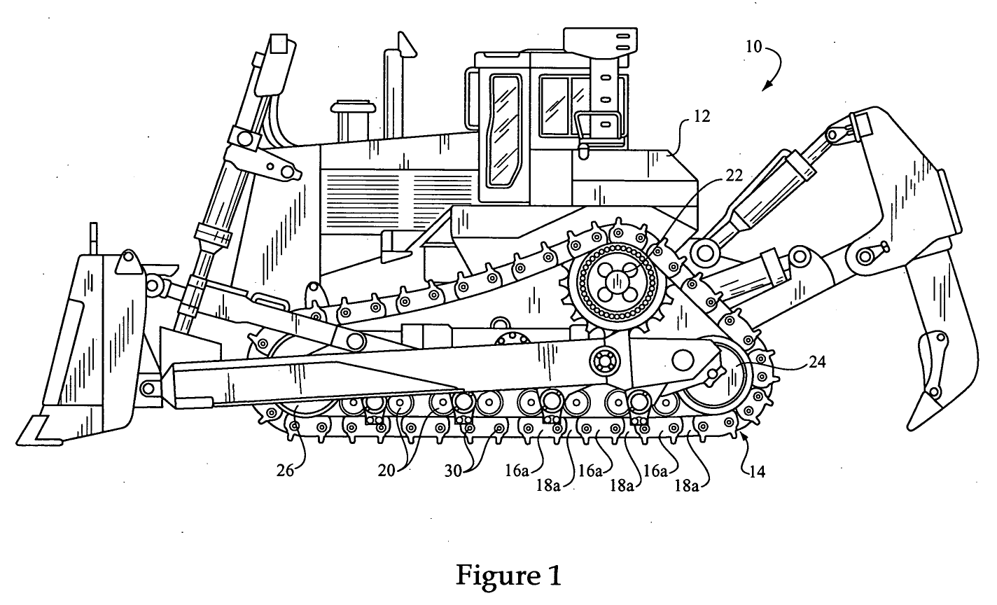

Referring to FIG. 1, there is shown a machine 10 according to one embodiment. Machine 10 may include a frame 12 and at least one track 14 coupled with frame 12. Track 14 may comprise an endless track extending about a plurality of rotatable elements, including for example a drive sprocket 22, a back idler 24 and a front idler 26, as well as a plurality of track rollers 20. Track 14 may further include a plurality of coupled together links forming two parallel track chains, coupled with track shoes in a conventional manner. In FIG. 1 a first set of links forming one chain is shown, including outboard and inboard links 16a and 18a. Each link 16a, 18a may be coupled to two adjacent links 16a, 18b with pins 30 to form an endless loop. Machine 10 is illustrated as a high drive track-type tractor, including a second track identical to track 14 disposed at an opposite side of frame 12 and therefore not visible in FIG. 1. It should be appreciated, however, that a wide variety of machines and track designs are contemplated within the context of the present disclosure. For example, rather than a track-type tractor, a half-track machine, an excavator, some other type of mobile machine, or even a stationary machine such as a conveyor might be constructed according to the teachings set forth herein. It is contemplated that in all embodiments, however, track 14 will comprise a “bolt together” track, which can be assembled for use or disassembled for replacement or repair using conventional hand tools. The term “bolt together” is used herein to describe a variety of coupling strategies and hardware elements for track 14 and other tracks according to the present disclosure which do not require the use of press fits, common to a great many other track designs. “Bolt together” should not be so narrowly construed, however, as to suggest a necessary use of conventional bolts, fasteners or any other specific retainer mechanism.

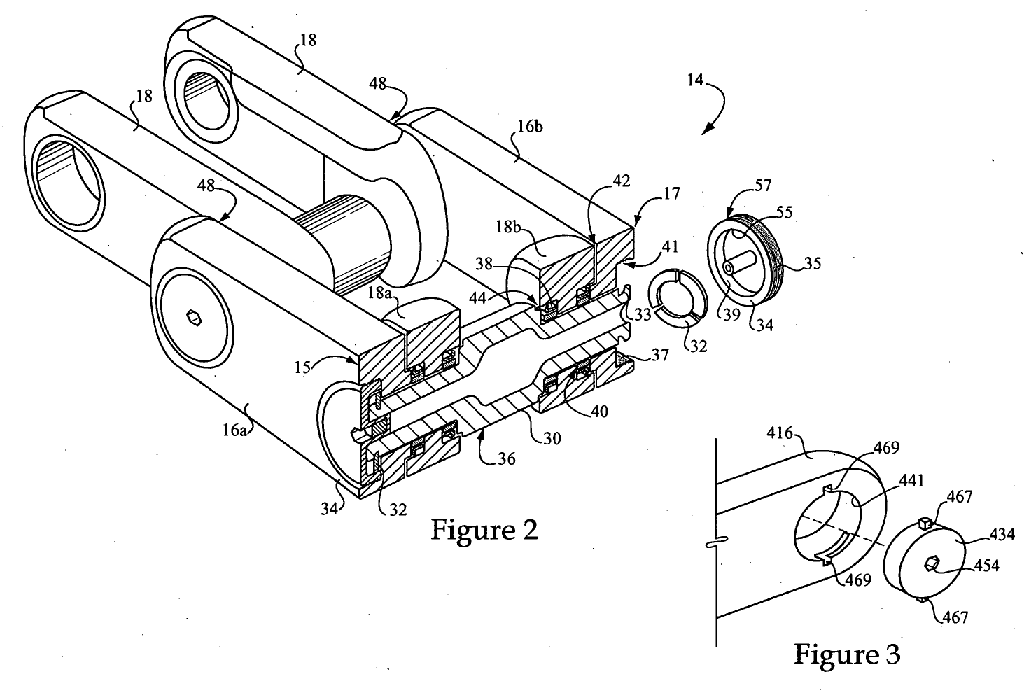

Turning now to FIG. 2, there is shown a sectioned view, in perspective, of a portion of track 14. In FIG. 2, portions of each set of links or chains are shown, a first set shown via numerals 16a and 18a, and the second set shown with numerals 16b and 18b. The respective chains are oriented parallel one another and typically are connected via pins 30, and bolted to track shoes (not shown in FIG. 2). As illustrated, outboard links 16a, 16b and inboard links 18a, 18b may each consist of straight links, although in other embodiments S-shaped links or some other configuration might be used. In the illustrated embodiment a single pin 30 extends through each of the two parallel sets of links 16a, 18a and 16b, 18b although separate pins might be used with each set of links in other embodiments. Each group of one or more pins 30, a first set of links including an outboard link 16a, 16b and an inboard link 18a, 18b, and a second set of links also including an outboard link 16a, 16b and an inboard link 18a, 18b may be understood as comprising a segment of track 14, which accordingly consists of a plurality of coupled together track segments.

Outboard links 16a, 16b and inboard links 18a, 18b of each respective set of links of a given track segment will together comprise a rail 48 upon which rollers 20 roll as track 14 is moved about the plurality of rotatable elements, 22, 24 and 26. Rails 48 may comprise a track outer edge 15 and a track inner edge 17 which are separated by a distance, i.e. a width of track 14, equal to or greater than a length of pin 30. The relatively greater width of track 14 between edges 15 and 17 can provide a relatively wider rail surface for supporting rollers 20, and accordingly a relatively greater amount of available wear material as compared to certain earlier designs, prolonging a service life of track 14, as well as providing other advantages described herein.

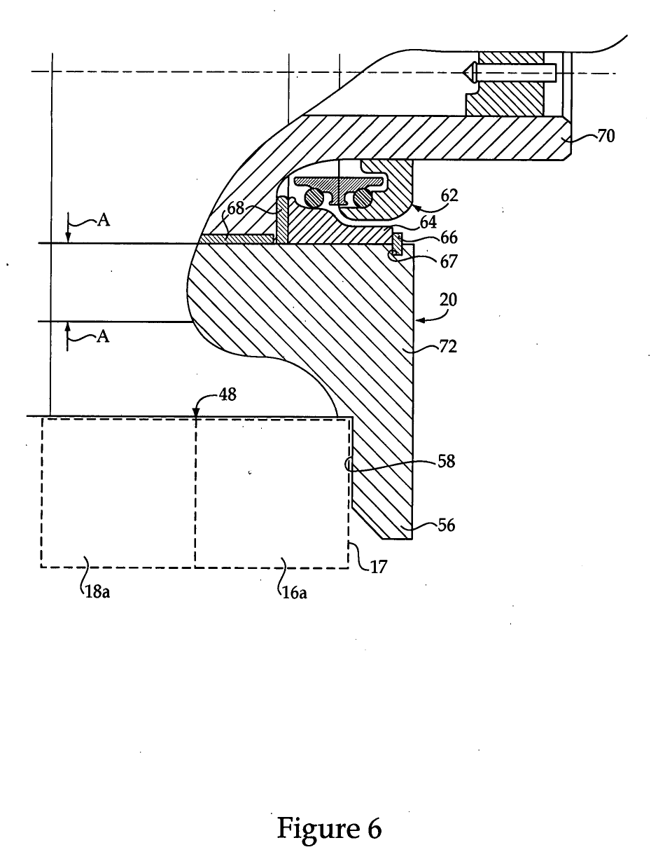

Turning to FIG. 6, there is shown a portion of a track undercarriage including a track roller 20 as it might appear when positioned against rail 48 of one of the sets of links shown in FIG. 2. Roller 20 may include a roller shell 72 and a roller retainer 70, and a plurality of bearings 68 enabling roller shell 72 to rotate about retainer 70 in a conventional manner. Roller 20 may further include a seal 62 and a seal carrier 64. In one embodiment, roller shell 72 may be press fit with seal carrier 64 and retained therewith via a snap ring 66 positionable in a groove 67 of roller shell 72. The use of a press fit to couple roller shell 72 with seal carrier 64 differs from earlier strategies wherein a roller shell and seal carrier were bolted together. Eliminating bolts and instead using a press fit and snap ring retention system simplifies assembly and allows roller 20 to be relatively wider to accommodate an increased width of track 14 as compared to earlier designs. In other words, eliminating bolts frees up volume to permit a wider surface for engaging roller shell 72 with rail 48, and also increases a thickness of available wear material, shown via arrows A in FIG. 6, to prolong a service life of roller 20.

Roller 20 may further include a guide flange 56 located proximate each of its ends, only one of which is shown in FIG. 6. Flange 56 extends downwardly relative to rail 48 and may include a planar inner flange surface 58 oriented perpendicular an axis of rotation of roller 20 and opposed to an edge 17 of track 14. A planar flange may be relatively easier to machine than conventional, sloped flanges, and provide for better track guiding, but is not critical. A distance between each flange 56 will be greater than a distance between edges 15 and 17 of track 14, and will accordingly typically be greater than a length of pin 30. Since the respective flanges 56 will be separated by a distance greater than a length of pin 30, flanges 56 may be relatively longer in a direction perpendicular to an axis of rotation of roller 20, providing for improved track guiding relative to each roller 20 than that available in earlier designs wherein roller flanges were made relatively shorter to avoid striking the ends of track pins. The combination of wider tracks, wider roller surfaces which engage the tracks and additional wear material on the track rails and rollers together are considered to provide a substantially more robust track design than that previously available. In addition, the elimination of bolts in coupling track roller components together, and the elimination of press fits in assembly of the track itself result in substantially easier assembly and servicing than in earlier designs, and can be retrofitted to existing machines since no re-design or modification of the machine undercarriage need be made.

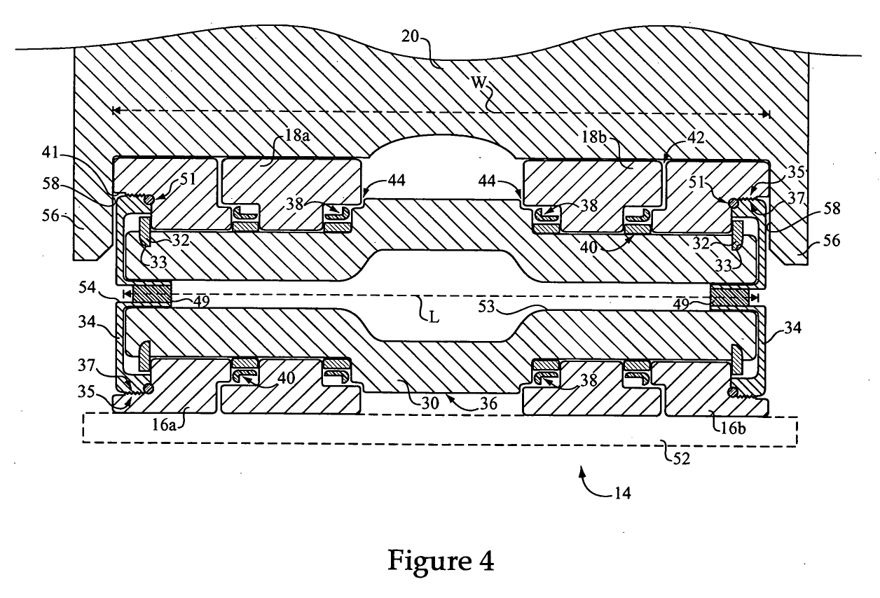

Returning to FIG. 2 and now referring also to FIG. 4, retention of the sets of links 16a, 18a and 16b, 18b on pin 30 is facilitated by a retainer assembly design different from other known strategies, providing relatively easier assembly and disassembly, without the use of hydraulic presses as mentioned above. In particular, first and second retainer assemblies, each consisting of one or more keepers 32 and a keeper retainer 34 which may comprise an end cap, may be positioned at opposite ends of pin 30 to inhibit disassembly of links 16a, 18a and 16b, 18b from pin 30. In one embodiment, keepers 32 may consist of a set of arcuate-shaped keepers 32 positionable in a groove 33, for example an annular groove, proximate each end of pin 30.

The following description of a single retainer assembly and one of the sets of links 16a, 18a, 16b, 18b should be understood to refer to installation of the links and retainer assemblies at each end of pin 30, as track 14 will typically be symmetrical about a midpoint of each pin 30. Likewise, track 14 will typically consist of identical track segments, and in some embodiments could even consist entirely of uniform links, and accordingly the present description should be understood to refer to assembly and/or disassembly of track 14 at any location. When positioned in groove 33, keepers 32 will inhibit sliding of each set of links 16a, 18a and 16b, 18b off of pin 30. Keeper retainer 34 may in turn be engaged with outboard link 16b to position a flange 39 about keepers 32 to maintain keepers 32 in their respective positions within groove 33. Engagement of keeper retainer 34 may be achieved via an interlocking feature 35 positioned on at least one of an inner diameter 55 and an outer diameter 57 of keeper retainer 34. As used herein, “interlocking feature” should be understood to mean some structural element or adaptation other than regular surfaces used in plain press fits. In one embodiment, interlocking feature 35 may consist of external threads on keeper retainer 34 which are configured to threadingly engage with internal threads 37 in a bore 31 of outboard link 16b. Accordingly, as further described herein assembly of track 14 may be achieved at least in part by positioning links 16a, 18a and 16b, 18b on pin 30, then placing keepers 32 within grooves 33, and threading keeper retainers 34 into engagement with each outboard link 16a, 16b.

Referring to FIG. 3, there is shown an alternative embodiment wherein rather than external threads, a keeper retainer 434 is engaged with a track link 416 via one or more tabs 467 positionable within corresponding angled slots 469 within a bore 441 of a track link 416. Keeper retainer 434 may otherwise be configured similarly to keeper retainer 34 described above, having a flange positionable about keepers to maintain them in engagement in a groove in a pin extending through bore 441. Keeper retainer 434 may also include a shaped opening or recess 454 configured to receive a complementary tool such as a hex wrench for rotating keeper retainer 434 to engage tabs 467 in slots 469. Fasteners, plugs, seals or the like might be positioned in slots 469 after keeper retainer 434 is engaged in bore 441 to inhibit decoupling of keeper retainer 434 from link 416. Keeper retainer 34, as well as the other keeper retainers described herein, may similarly include shaped openings for receiving a wrench or the like.

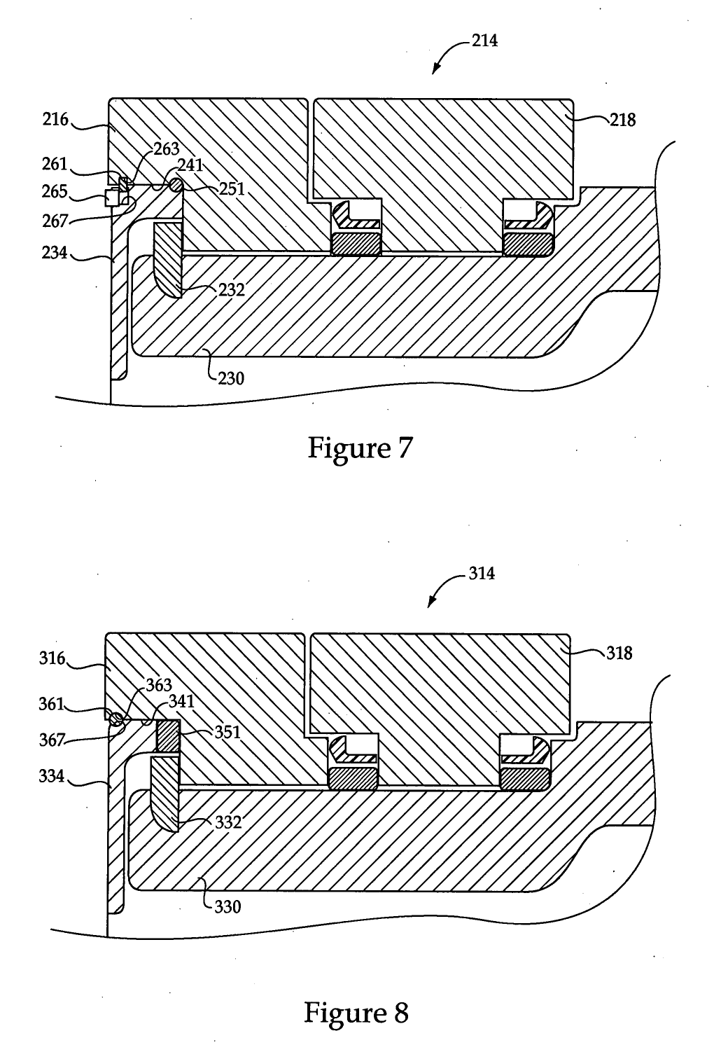

Turning now to FIG. 7, there is shown a portion of another track 214 according to yet another embodiment. Track 214 may be configured similarly to track 14 but may include an alternative configuration of its keeper retainer 234. Keeper retainer 234 engages with an outboard link 216 by non-rotationally interlocking therewith and maintaining keepers 232 in engagement with a pin 230, in turn inhibiting disassembly of outboard link 216 and an inboard link 218 from pin 230. In particular, keeper retainer 234 is retained with track 214 via a snap ring 261 positionable within a groove 263 within a bore 241 of outboard link 216. Ring 261 may be compressed, then permitted to expand to allow insertion and removal from groove 263. Keeper retainer 234 has an interlocking feature for coupling retainer 234 with link 216 comprising a shoulder 267, for instance an annular shoulder, which is configured to engage with ring 261 when it is within groove 263. One or more fasteners or pins 265 may be provided to engage with keeper retainer 234 and ensure that ring 261 remains in its desired position. An O-ring seal 251 may also be provided to prevent fluid leakage around retainer 234 and assist in sealing lubricating fluid within and among components of track 214. In one embodiment, ring 261 may include ends having ears for receipt of the points of pliers or the like for insertion/removal.

Turning now to FIG. 8, there is shown a portion of a track 314 and retainer assembly consisting of keepers 332 and a keeper retainer 334 according to yet another embodiment. Track 314 is again similar to the aforementioned designs but has yet another configuration and assembly method for its keeper retainer 334. Track 314 includes outboard links 316, inboard links 318 and a pin 330. Keeper retainer 334 is positionable within a bore 341 in outboard link 316 to inhibit disassembly of keepers 332 from their intended positions. A compressible, elastic seal member 351, for instance an annular elastomeric seal, is positioned within bore 341 and provides a biasing force biasing keeper retainer 334 outwardly of bore 341. A trapped ring 361 is positionable within a groove 369 in outboard link 316, and configured to bear against a shoulder 367 on keeper retainer 334. Trapped ring 361 may comprise a split ring of spring steel, for example. Ends of ring 361 may be lifted out of groove 369 for removal therefrom and disassembly of track 314. Slots in link 316 might be used to provide access to remove ring 361 via a flat screw driver or the like. Accordingly, when keeper retainer 334 is pressed inwardly into bore 341, it can compress seal 351, which then exerts an outward biasing force to interlock keeper retainer 334 with track 314 via an interaction between ring 361 and shoulder 367.

Returning to the embodiment of FIGS. 2 and 4, track 14 may further have a unique configuration for protecting seals from entry of foreign material. An inboard seal 38 may be positioned on each side of a bushing 36 configured to engage with drive sprocket 22, and outboard seals 40 may be positioned between each inboard link 18a, 18b and each outboard link 16a, 16b. An outboard labyrinth 42, defined in part by each outboard link 16a, 16b and also in part by each inboard link 18a, 18b, may be provided. Each outboard labyrinth 42 may consist of an angled gap between outboard links 16a, 16b and inboard links 18a, 18b to inhibit entry of debris into the general area of each outboard seal 40. Track 14 may further include inboard labyrinths 44 also comprising angled passages, which inhibit entry of debris into the area of inboard seals 38. Inboard labyrinths 44 may be defined in part by bushing 36, and also in part by inboard links 18a, 18b. It will be appreciated that labyrinths 42 and 44 may comprise generally annular angled passages, circumferential of pin 30, as they are located at respective interfaces between links 16a, 16b and 18a, 18b and between links 18a, 18b and bushing 36. It should further be appreciated that pin 30 may be loose-fitted with links 16a, 18a and 16b, 18b such that pin 30 and its integral bushing 36 can rotate as it engages with toothed rotating members such as drive sprocket 22 and idlers 24 and 26. Bores 41 in outboard links 16a, 16b and corresponding bores in inboard links 18a, 18b may be furnace hardened, as may pin 30, to enable links 16a, 18a and 16b, 18b to turn directly on pin 30 without the need for bushings or the like. Where links turn directly on pin 30, galling and/or carburizing of components may be reduced over designs using bushings, etc. Embodiments are contemplated wherein interfaces between outboard links 16a, 16b and inboard links 18a, 18b, respectively, and between links 18a, 18b and bushing 36 do not include labyrinths, but instead consist of simple parallel faces. However, given the relatively greater width of track 14 as compared with many earlier designs, a greater relative thickness of links 16a, 18a and 16b, 18b will typically be available which enables the use of seal-protecting labyrinths without sacrificing any substantial link robustness. It may also be noted from the illustration in FIG. 4 that track 14 may include a plug 49 at each end of pin 30 to fluidly seal an interior passage 53. Track shoes 52, for example a single shoe extending across track 14 may be bolted with links 16a, 16b and 18a, 18b in a conventional manner.

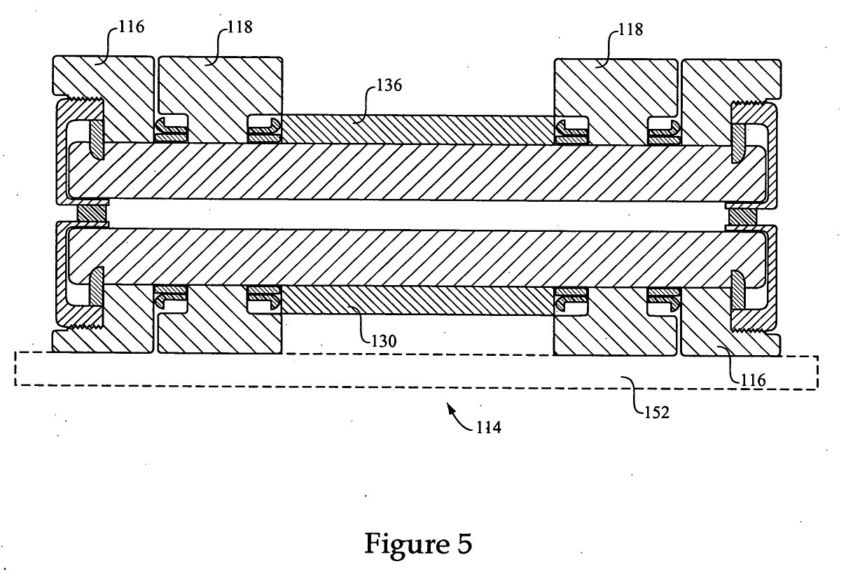

Turning to FIG. 5, there is shown a track 114 similar to track 14 described above, but differing in that rather than an integral bushing, a separate rotating bushing 136 is provided which is positioned about pin 130. Track 114 may also include outboard links 116 and inboard links 118 coupled with a track shoe 152. An integral bushing may be used in certain embodiments, as such a design tends to be more rigid, lighter and less expensive than two-piece pin and bushing systems, though such a design is not critical as shown via the FIG. 5 illustration.

### INDUSTRIAL APPLICABILITY

Assembly of a track according to the present disclosure such as track 14, shown in detail in FIGS. 2 and 4, will typically be initiated by loose-fitting a first set of links, including an inboard link 18b and outboard link 16b onto pin 30. Where a separate pin and bushing are used, as in the FIG. 5 embodiment, bushing 136 will typically be positioned on its respective pin 130 in advance of positioning links thereon. Inboard and outboard seals 38 and 40 corresponding to the set of links will also be positioned appropriately about pin 30. Seals 38 and 40 will typically be compressible and when uncompressed will occupy sufficient space on pin 30 such that groove 33 at the corresponding end of pin 30 is obscured by outboard link 16. Next, outboard link 16b may be urged toward inboard link 18b such that seals 38 and 40 are compressed, and groove 33 is exposed.

Keepers 32 may then be placed in groove 33, and the force on outboard link 16b relaxed. Seals 38 and 40 will then tend to bias outboard link 16b against keepers 32 such that they are held in place in groove 33. As may be noted from the Figures, keepers 32 may have a shape such that a biasing force from seals 38 and 40 on outboard link 16b does not result in keepers 32 being displaced. Keeper retainer 34 may then be engaged in bore 41 via its external threads 35 and internal threads 37 in bore 41. As mentioned above with regard to the embodiment of FIG. 3, a similar shaped recess on keeper retainer 34 may be engaged with a tool to enable tightening of keeper retainer 34 and secure engagement with link 16b. When engaged thusly, flange 39 may extend about keepers 32 such that they will be retained in position. The respective keepers 32 and keeper retainer 34 corresponding to the opposite set of links 16a and 18a may be engaged in a similar manner to complete assembly of the respective two sets of links on pin 30.

Disassembly of track 14 for servicing, part replacement, etc. may take place generally in the reverse of the process described above. A tool such as a wrench may be used to loosen keeper retainer 34 by rotating and subsequently remove it from engagement with the corresponding outboard link 16a, 16b. Keepers 32 may then be readily removed from groove 33 at each end of pin 30 to enable links 16a, 18a and 16b, 18b to be slipped off of pin 30. This process may be repeated for the other set of links. Assembly and disassembly of the other track embodiments described herein may take place in a similar manner, albeit without rotationally interlocking the respective keeper retainers, as discussed above.

Those skilled in the art will be familiar with various track designs wherein press fits are used to couple components together. As used herein, the term “interlock” should be understood to be a retention strategy different from press-fits. “Rotationally interlocking,” such as between retainers 34 and links 16a, 16b should be understood as a retention strategy other than press fits, wherein rotation is used to lock the parts together. In all embodiments contemplated herein, “interlocking” of the respective parts as described shall be understood as a locking together which does not rely solely on frictional interaction between an outer diameter cylindrical surface of one part and an inner diameter cylindrical surface of another part, as is the case with press-fits.

The present disclosure accordingly provides a track design and assembly/disassembly method that is simpler than earlier strategies. Rather than relying upon press fits, welds, complex pin retention assemblies, crimping or other labor intensive joining techniques, the present disclosure provides machine track suitable for use in rugged, off-road environments that can be easily serviced in the field. The present track design further provides for the use of additional wear material between components, a lower link profile, improved track-roller guiding and relatively wider track to cover the seals, provide labyrinths, and cover the keepers and end caps. The present track designs further provide additional spacing for bolts which retain the track shoes to improve shoe retention, and bushing length may be reduced. The relatively wider track, having the attendant advantages described herein can also be retrofitted to existing machines without substantial modifications thereof. The presently described designs further enable all of the links of a given track to function as master links.

The present description is for illustrative purposes only, and should not be construed to narrow the breadth of the present disclosure in any way. Thus, those skilled in the art will appreciate that various modifications might be made to the presently disclosed embodiments without departing from the intended spirit and full and fair scope of the present disclosure. For instance, while each of the illustrated designs includes a plurality of arcuate keepers, in other embodiments a different keeper configuration might be used such as pins positioned in bores in the track pin. In addition, seals or washers might be positioned on the track pins to reduce end play in certain embodiments, for example between outboard links 16a, 16b and keepers 32, if desired. Other aspects, features and advantages will be apparent upon an examination of the attached drawings and appended claims.

What is claimed is:

1. A machine track comprising:
a plurality of track segments each having a first set of links, a second set of links positioned in parallel with said first set and at least one pin coupling together the respective links of each set;
wherein each of said plurality of track segments comprises a first retainer assembly for said first set of links and a second retainer assembly for said second set of links, each of said retainer assemblies including at least one keeper engageable with said at least one pin and a keeper retainer having an inner diameter, an outer diameter and an interlocking feature disposed on at least one of said inner and outer diameters.

2. The machine track of claim 1 wherein said links comprise straight links.

3. The machine track of claim 2 wherein each of said keeper retainers rotationally interlocks with one of said links via its interlocking feature.

4. The machine track of claim 3 wherein the interlocking feature of each of said keeper retainers comprises external threads.

5. The machine track of claim 4 wherein the at least one pin of each of said track segments comprises a single pin having an integral bushing.

6. The machine track of claim 4 wherein each of said track segments includes a bushing, and wherein each of said sets of track links includes an inboard link adjacent said bushing and an outboard link, each of said track segments further comprising inboard labyrinths defined in part by said bushing and in part by said inboard links, and outboard labyrinths defined in part by the inboard link and outboard link of each of the sets of links.

7. The machine track of claim 4 wherein each of said retainer assemblies comprises a plurality of keepers, and wherein each of said keeper retainers comprises an end cap having a flange maintaining the corresponding keepers engaged with the corresponding at least one pin.

8. The machine track of claim 2 further comprising a plurality of track rollers each having a first guide flange and a second guide flange, said guide flanges spaced apart by a distance greater than a length of said at least one pin.

9. The machine track of claim 8 wherein each of said sets of links includes a rail having an outer edge, wherein the guide flanges of each of said track rollers are positionable outboard of said outer edges, and wherein each of said track segments has a width dimension extending between said outer edges which is equal to or greater than the length of said at least one pin.

10. The machine track of claim 9 wherein each of said track rollers includes a roller shell and a seal carrier press fit with the roller shell and retained therewith via at least one snap ring.

11. An assembly for coupling together components of a machine track comprising:
a track link pin;
at least one keeper engaged with said pin; and
a keeper retainer configured to maintain said at least one keeper in engagement with said pin, said keeper retainer having an inner diameter, an outer diameter and an interlocking feature disposed on at least one of said inner and outer diameters.

12. The assembly of claim 11 wherein said at least one keeper comprises a plurality of keepers, said pin having a first end with an annular groove adapted to receive keepers therein and a second end having another annular groove also adapted to receive keepers therein.

13. The assembly of claim 12 comprising a plurality of keeper retainers each configured to maintain a set of said keepers in engagement with said pin, wherein said interlocking feature comprises threads for rotationally interlocking with the machine track.

14. The assembly of claim 13 wherein each of said keeper retainers comprises an end cap, and wherein said interlocking feature comprises external threads on each of said end caps, said keeper retainers each further including a shaped opening adapted to receive a tool for engaging/disengaging the corresponding end cap with the machine track.

15. A method of assembling a machine track segment comprising the steps of:
positioning a first set of track links and a second set of track links on at least one pin;
installing keepers on the at least one pin at positions outboard of the respective sets of track links; and
inhibiting disassembly of the sets of links from the at least one pin at least in part by engaging keeper retainers with the machine track segment via an interlocking feature of each of the keeper retainers.

16. The method of claim 15 wherein the step of installing keepers on the at least one pin further comprises positioning a plurality of keepers in a first groove at a first end of the at least one pin and positioning another plurality of keepers in a second groove at a second end of the at least one pin, and wherein the step of inhibiting disassembly of the links further comprises maintaining engagement between the keepers and the at least one pin with threaded end caps mated to threaded bores in outboard links of each set of track links.

17. The method of claim 16 further comprising the steps of:
moving the outboard links inwardly against a biasing force of compressible seals to uncover the grooves on the pin; and
maintaining the keepers in installed positions via the biasing force of the compressible seals prior to engaging keeper retainers with the machine track segment.
